(19) United States
(12) Patent Application Publication
(10) Pub. No.: US 2026/0027717 A1
(43) Pub. Date: Jan. 29, 2026

(54) INFORMATION PROCESSING METHOD, ROBOT SYSTEM, INFORMATION PROCESSING APPARATUS, METHOD FOR MANUFACTURING A PRODUCT, AND RECORDING MEDIUM

(71) Applicant: CANON KABUSHIKI KAISHA, Tokyo (JP)

(72) Inventor: YUKO KAWAGUCHI, Kanagawa (JP)

(21) Appl. No.: 19/272,572

(22) Filed: Jul. 17, 2025

(30) Foreign Application Priority Data
Jul. 24, 2024 (JP) 2024-118692

(51) Int. Cl. B25J 9/16

(52) U.S. Cl. CPC B25J 9/1671; B25J 9/163; B25J 9/1653

(57) ABSTRACT

An information processing method executed by a processor including execute first processing that causes a second robot model to perform a virtual operation by using configuration information used to cause a first robot model to perform a virtual operation, and in a case where the second robot model has taken a specific state as a result of executing the first processing, execute second processing that notifies a user of the configuration information that has caused the second robot model to take the specific state.

### BACKGROUND

### Field of the Technology

The present disclosure relates to information processing associated with control of a robot.

### Description of the Related Art

In recent years, in industrial manufacture lines, operations such as assembly, conveyance, and application are automated by systems including robots. Simulation techniques with which the operation of the robot can be studied and tested in advance in a virtual space instead of a real space is studied.

In the study of the operation of the robot, when the model of the robot is changed on a simulator, any teaching points that have been set need to be created again due to the difference in the robot operation mechanism resulting from the change. This requires a lot of work from an operator (user).

To address this, Japanese Patent Application Laid-Open No. 2007-226290 discloses a teaching apparatus that changes position data in an operation program of a first robot in accordance with a conversion condition and generates an operation program of a second robot such that control points of the second robot operate in a similar manner to control points of the first robot.

However, the entire configuration information corresponding to the first robot such as teaching point information is not necessarily applicable to the second robot.

### SUMMARY

The present disclosure provides a technique advantageous for setting the operation of a robot.

According to a first aspect of the present disclosure, an information processing method executed by a processor including execute first processing that causes a second robot model to perform a virtual operation by using configuration information used to cause a first robot model to perform a virtual operation, and in a case where the second robot model has taken a specific state as a result of executing the first processing, execute second processing that notifies a user of the configuration information that has caused the second robot model to take the specific state.

According to a second aspect of the present disclosure, an information processing apparatus includes a memory storing instructions, and a processor. The processor, that upon execution of the stored instructions, is configured to perform information processing including causing a second robot model to perform a virtual operation by using configuration information used for causing a first robot model to perform a virtual operation, and in a case where the second robot model has taken a specific state as a result of causing the second robot model to perform a virtual operation, notify a user of the configuration information that has caused the second robot model to take the specific state.

Features of the present disclosure will become apparent from the following description of embodiments with reference to the attached drawings. The following description of embodiments is described by way of example.

### BRIEF DESCRIPTION OF THE DRAWINGS

FIG. 1 is an explanatory diagram illustrating a schematic configuration of a robot system according to an embodiment.

FIG. 2A is a diagram for describing a configuration of a robot arm and a robot hand according to the embodiment.

FIG. 2B is an explanatory diagram of a robot hand according to the embodiment.

FIG. 3 is an explanatory diagram of a simulator according to the embodiment.

FIG. 4 is a block diagram of a computer system according to the embodiment.

FIG. 5 is an explanatory diagram of a robot changing window according to the embodiment.

FIG. 6 is a flowchart related to a robot changing process according to the embodiment.

FIG. 7 is a flowchart of part of the robot changing process according to the embodiment.

FIG. 8 is an explanatory diagram of processing according to the embodiment.

FIG. 9 is a flowchart of part of the robot changing process according to the embodiment.

FIG. 10 is an explanatory diagram of processing according to the embodiment.

FIG. 11 is a flowchart of part of the robot changing process according to the embodiment.

FIG. 12 is an explanatory diagram of processing according to the embodiment.

FIG. 13 is an explanatory diagram of processing according to the embodiment.

FIG. 14 is a flowchart of an information processing method according to the embodiment.

FIG. 15 is an explanatory diagram of a display screen according to the embodiment.

FIG. 16 is an explanatory diagram of a presentation screen according to the embodiment.

### DESCRIPTION OF THE EMBODIMENTS

An embodiment will be described below with reference to attached drawings. To be noted, the embodiment described below is merely an example, and for example, details of the configuration thereof can be appropriately modified by one skilled in the art within the gist of the present disclosure.

To be noted, in the description below, an X axis, a Y axis, and a Z axis represent axes of the coordinate system of the entire robot system. The three-dimensional coordinate system defined by the X axis, Y axis, and Z axis represents a world coordinate system of the entire environment in which the robot system is installed. In addition to this, local coordinate systems may be appropriately used for a robot hand, a finger portion, a joint, and the like for the sake of convenience of control or the like.

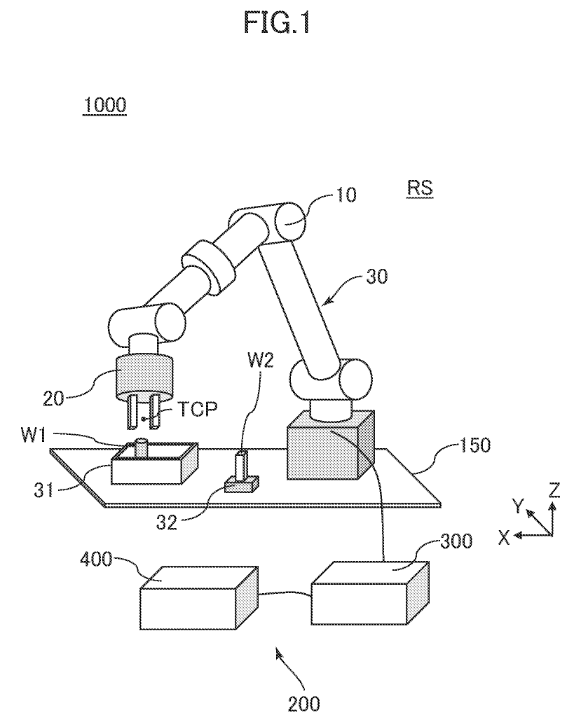

FIG. 1 is an explanatory diagram illustrating a schematic configuration of a robot system 1000 according to the embodiment. FIG. 1 schematically illustrates the robot system 1000 in a real space RS. The robot system 1000 includes a robot 30 and a computer system 200 serving as an example of a control apparatus. The computer system 200 is constituted by a plurality of computers, and includes a robot controller 300, and a simulator 400 serving as an example of an information processing apparatus in the present embodiment.

The robot 30 is an industrial robot and is, for example, a manipulator. The robot 30 is fixed to, for example, a stand 150. For example, a tray 31 on which a workpiece W1 serving as a conveyance target object is disposed and a workpiece W2 to which the workpiece W1 is to be coupled are disposed around the robot 30. The workpiece W1 is held by the robot 30 and conveyed to a position where the workpiece W1 is coupled to the workpiece W2.

The robot 30 and the robot controller 300 are interconnected by wiring that transmits data (information). The robot controller 300 and the simulator 400 are interconnected by wiring capable of transmitting data (information).

The robot 30 includes a robot arm 10 and a robot hand 20 serving as an example of an end effector. The robot arm 10 is, for example, a vertically articulated robot arm. The robot hand 20 is supported by the robot arm 10. The robot hand 20 is attached to a predetermined portion of the robot arm 10, for example, a distal end portion of the robot arm 10. The robot hand 20 is configured to be capable of holding the workpiece W1.

The simulator 400 performs offline teaching, that is, virtually executes the operation of the robot 30 by computer simulation, and displays a simulation result on a screen. The robot controller 300 obtains information of a plurality of teaching points for the robot 30 from the simulator 400. For example, the robot controller 300 obtains information corresponding to a first teaching point serving as a position to hold the workpiece W1 from the simulator 400, and obtains, from the simulator 400, information corresponding to a second teaching point serving as a position to which the workpiece W1 is to be conveyed. The robot controller 300 generates trajectory data of the robot 30 from the first teaching point to the second teaching point. The robot controller 300 controls the robot 30 in accordance with the generated trajectory data to cause the robot 30 to perform an operation of conveying the workpiece W1 and coupling the workpiece W1 to workpiece W2. As a result of this, a product such as an industrial product can be manufactured. To be noted, the calculation of the trajectory data may be performed by the simulator 400. In addition, the product to be manufactured may be an intermediate product or a final product.

The robot 30 needs to be taught such that the robot 30 does not come into contact with objects around the robot 30 when the robot 30 conveys the workpiece W1. Teaching the robot 30 means setting teaching points for obtaining the trajectory data of the robot 30.

A control point that moves in an interlocked manner with a predetermined portion of the robot 30 is defined for the robot 30. The predetermined portion of the robot 30 is, for example, the robot hand 20. The control point is, for example, a tool center point (TCP), and is set in the vicinity of the predetermined portion of the robot 30, for example, in the vicinity of the robot hand 20. By teaching the position and posture of the TCP, a teaching point indicating a position and a posture is set. The teaching point is set by parameters of a task space or a joint space. In the case of the task space, the teaching point is constituted by three pieces of position information and three pieces of posture information. The teaching point defined in the task space can be converted into a teaching point defined in a joint space. For example, the teaching point defined in the joint space is constituted by information of six joint positions (joint angles) in the case of a six-axis robot. The arithmetic processing to convert a teaching point defined in the task space into a teaching point defined in the joint space is performed on the basis of, for example, inverse kinematics calculation of the robot 30.

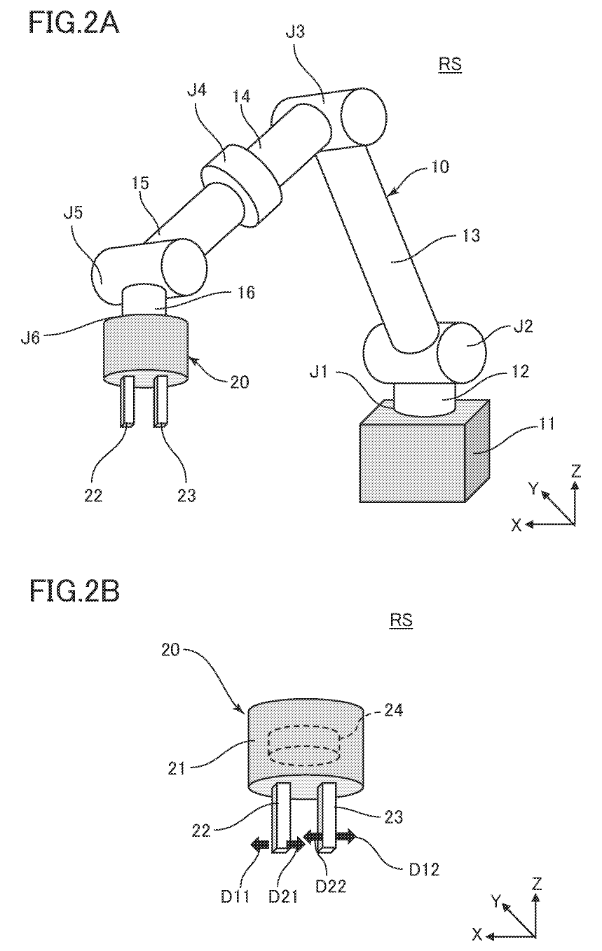

FIG. 2A is a diagram for describing a configuration of the robot arm 10 and the robot hand 20 according to the embodiment. The robot arm 10 includes a plurality of links 11 to 16 interconnected by a plurality of joints J1 to J6. The plurality of joints J1 to J6 are each a rotary joint. To be noted, the robot arm 10 may include a prismatic joint. The link 11 serving as a base of the robot arm 10 (base of the robot 30) is fixed to the stand 150. Each of the joints of the robot arm 10 is provided with a motor serving as a drive source that drives the corresponding joint, a reduction gear that outputs the rotation of the motor in a reduced manner, and an encoder serving as a position detection apparatus that detects the rotational angle of the motor. To be noted, where the encoder is installed and the format of the output are not limited. The robot hand 20 is attached to the link 16 that is a distal end portion of the robot arm 10. The robot 30 can be operated into various postures by driving the joints J1 to J6 of the robot arm 10.

FIG. 2B is an explanatory diagram of the robot hand 20 according to the embodiment. The robot hand 20 includes a palm portion 21, and a plurality of finger portions openably and closably supported by the palm portion 21, for example, two finger portions 22 and 23. The two finger portions 22 and 23 are disposed to oppose each other. The robot hand 20 has a force control function of operating the finger portions 22 and 23 by a constant force. In addition, the palm portion 21 of the robot hand 20 supports the finger portions 22 and 23, and includes a driving portion 24 that causes linear motion of the pair of finger portions 22 and 23. The driving portion 24 includes a motor, a conversion mechanism for converting the rotational motion of the motor into a linear motion, and the like. By operating the driving portion 24, the finger portions 22 and 23 can be linearly moved in opening directions D11 and D12 and closing directions D21 and D22 indicated by arrows in FIG. 2B. The driving portion 24 can generate a holding force for holding the workpiece W1 in the finger portions 22 and 23 by generating the driving force. The robot hand 20 may hold the workpiece W1 such that the workpiece W1 does not relatively move with respect to the robot arm 10. To be noted, although the number of the finger portions is set to two in the present embodiment, the configuration is not limited to this, and for example, the number of the finger portions may be three or more. In addition, although the robot hand 20 is configured to move the finger portions thereof by being driven by a motor in the present embodiment, the configuration is not limited to this, and for example, the robot hand 20 may be an air gripper that is driven by air pressure.

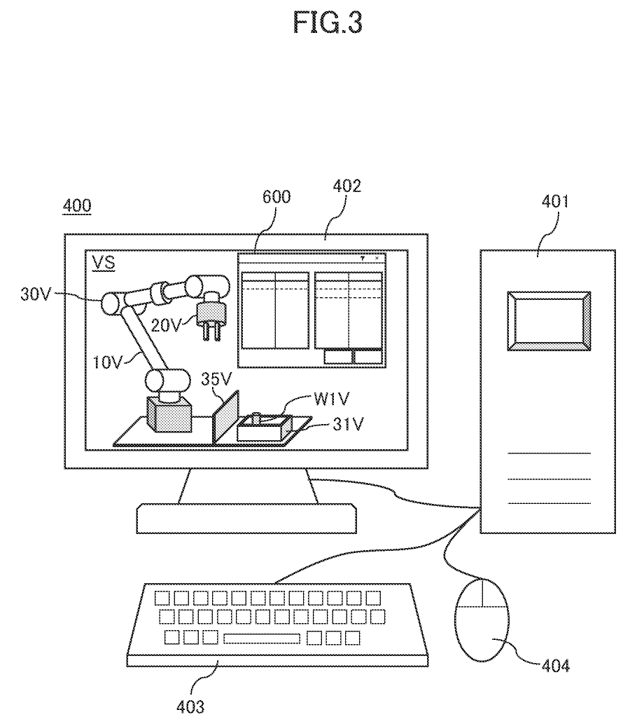

FIG. 3 is an explanatory diagram of the simulator 400 according to the embodiment. The simulator 400 is an example of an information processing apparatus, and includes a simulator body 401, a display 402 that is an example of a display apparatus connected to the simulator body 401, and a keyboard 403 and a mouse 404 serving as an example of an input device connected to the simulator body 401. The display 402 displays a robot changing window 600 as a result of the simulator body 401 executing application software for realizing a simulation method (information processing method). In addition, the display 402 displays a virtual space VS defined by the simulator body 401. A robot model 30V, a workpiece model W1V, a tray model 31V, a wall model 35V, and the like are disposed in the virtual space VS, and these are displayed on the display 402 as 2D or 3D images. The robot model 30V includes an arm model 10V corresponding to the robot arm 10 and a hand model 20V corresponding to the robot hand 20. To be noted, it is assumed that a case where an unillustrated wall is disposed around the tray 32 and the workpiece W2 of FIG. 1 is simulated.

The robot model 30V is a virtual robot corresponding to the robot 30. The robot model 30V is an example of a first robot model. The workpiece model W1V is a virtual workpiece corresponding to the workpiece W1. The tray model 31V is a virtual tray corresponding to the tray 31. The wall model 35V is a virtual wall corresponding to the unillustrated wall. The tray model 31V and/or the wall model 35V is an example of an obstacle model that can serve as an obstacle for a virtual operation of the robot model 30V.

Each model is a three-dimensional model, and includes three-dimensional shape information (data). The three-dimensional shape information is, for example, registered in the simulator body 401 in advance as 3D-CAD data. The operator can input the data to the simulator body 401 by operating the keyboard 403 and the mouse 404, and thus cause the simulator body 401 to simulate the operation of the robot model 30V corresponding to the robot 30 in the virtual space VS. That is, the simulator body 401 can perform simulation processing of virtually operating the robot model 30V.

To be noted, although a case where the simulator 400 is a desktop personal computer (PC) that is generally used will be described as an example in the present embodiment, the configuration is not limited to this. For example, the simulator 400 may be a terminal apparatus such as a tablet PC or a laptop PC, or may be a teaching pendant having a simulator function. That is, the simulator 400 may be an information processing apparatus in which the input device and the display apparatus are integrated.

Teaching regarding the operation of the robot 30 can be performed by offline teaching using the simulator 400. Determining the operation of the robot 30 includes determining the rotation amount of the joints J1 to J6. In the case where the robot hand 20 includes a joint and can change the positions of the finger portions 22 and 23 in the rotational direction, determining the operation of the robot 30 may include determining the rotation amount of the joint of the robot hand 20.

The workpiece W1 can be held by moving the finger portions 22 and 23 of the robot hand 20 in the open state in the closing direction to bring the finger portions 22 and 23 into contact with the workpiece W1 and giving a holding force to the finger portions 22 and 23. A holding position is a relative position of the robot 30 with respect to the workpiece W1 when the robot 30 holds the workpiece W1. The holding position corresponds to the posture of the robot 30 when the robot 30 holds the workpiece W1 if the workpiece W1 is positioned with respect to the robot 30. Therefore, if the workpiece W1 is positioned with respect to the robot 30, the robot 30 can hold the workpiece W1 at a predetermined holding position by bringing the robot 30 into a predetermined posture.

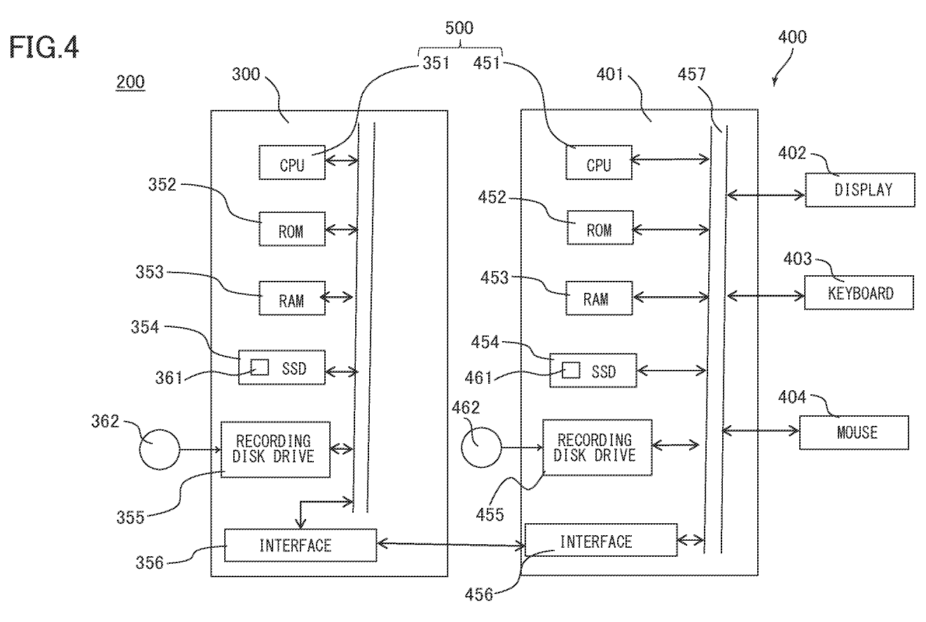

FIG. 4 is a block diagram of the computer system 200 according to the embodiment. The simulator body 401 of the simulator 400 includes a central processing unit (CPU) 451 serving as an example of a processor. The CPU 451 is an example of an information processing portion. In addition, the simulator body 401 includes a read-only memory (ROM) 452, a random access memory (RAM) 453, and a solid state drive (SSD) 454 as storage portions. In addition, the simulator body 401 includes a recording disk drive 455, and an interface 456 that is an interface for communicating with the robot controller 300. The CPU 451, the ROM 452, the RAM 453, the SSD 454, the recording disk drive 455, and the interface 456 are mutually communicably interconnected by a bus 457. In addition, the display 402, the keyboard 403, and the mouse 404 are each connected to the bus 457 via an interface.

The ROM 452 stores a basic program related to the operation of the computer. The RAM 453 is a storage device that temporarily stores various data such as arithmetic processing results of the CPU 451. The SSD 454 stores arithmetic processing results of the CPU 451, various data obtained from the outside, and the like, and also stores a program 461 for causing the CPU 451 to execute various processing. The program 461 is application software that can be executed by the CPU 451.

The CPU 451 can execute the program 461 stored in the SSD 454 to execute simulation processing, thus simulate the operation of a robot in the virtual space by using a virtual robot, and obtain data (information) of teaching points. The recording disk drive 455 can read various data, programs, and the like stored in a recording disk 462. The recording disk drive 455 can read data stored in the recording disk 462 serving as an example of a recording medium. Model data, simulation result data, and the like can be written on the recording disk 462 as moving image data (moving image file).

In addition, the CPU 451 may generate animation data including trajectory information of each control cycle of the model in the simulation in response to input of information from a user via the keyboard 403 or the mouse 404, and store the animation data in the ROM 452 or the SSD 454. The animation data includes teaching point information serving as a target value of the joint position of each shaft of the robot 30 and interference information between a plurality of models in addition to the trajectory information, and these pieces of information can be referred to in the simulation.

To be noted, although the SSD 454 serves as a non-transitory computer-readable recording medium and the program 461 is stored in the SSD 454 in the present embodiment, the configuration is not limited to this. The program 461 may be stored in any recording medium as long as the recording medium is a non-transitory computer-readable recording medium. As the recording medium for supplying the program 461 to the computer, for example, a flexible disk, a hard disk, an optical disk, a magneto-photo disk, a magnetic tape, a nonvolatile memory, or the like can be used. In addition, the program 461 may be obtained from an unillustrated network.

The robot controller 300 includes a CPU 351 serving as an example of a processor. In addition, the robot controller 300 includes a ROM 352, a RAM 353, and an SSD 354 as storage portions. In addition, the robot controller 300 includes a recording disk drive 355 and an interface 356 that is an interface for communicating with the simulator 400. The CPU 351, the ROM 352, the RAM 353, the SSD 354, the recording disk drive 355, and the interface 356 are mutually communicable connected to a bus 357.

The ROM 352 stores a basic program related to the operation of the computer. The RAM 353 is a storage device that temporarily stores various data such as arithmetic processing results of the CPU 351. The SSD 354 stores arithmetic processing results of the CPU 351, various data obtained from the outside, and the like, and also stores a program 361 for causing the CPU 351 to execute various processing. The program 361 is application software that can be executed by the CPU 351.

The CPU 351 can execute the program 361 stored in the SSD 354 to execute control processing, and thus control the operation of the robot 30 of FIG. 1. The recording disk drive 355 can read various data, programs, and the like stored in a recording disk 362.

To be noted, although the SSD 354 serves as a non-transitory computer-readable recording medium and the program 361 is stored in the SSD 354 in the present embodiment, the configuration is not limited to this. The program 361 may be stored in any recording medium as long as the recording medium is a non-transitory computer-readable recording medium. As the recording medium for supplying the program 361 to the computer, for example, a flexible disk, a hard disk, an optical disk, a magneto-photo disk, a magnetic tape, a nonvolatile memory, or the like can be used. In addition, the program 361 may be obtained from an unillustrated network.

In the present embodiment, a control portion 500 is constituted by the plurality of CPUs 351 and 451 that are capable of communicating with each other. In the present embodiment, the CPU 351 is in charge of the control processing, and the CPU 451 is in charge of the simulation processing (information processing). To be noted, although the control processing and the information processing are performed by a plurality of computers, that is, the plurality of CPUs 351 and 451 in the present embodiment, the configuration is not limited to this. The control processing and the information processing may be performed by one computer, that is, one CPU. In this case, the one CPU may be configured to function as a control portion and an information processing portion. In addition, although one processor is configured to perform the information processing in the present embodiment, the configuration is not limited to this, and a plurality of processors may be configured to execute the information processing.

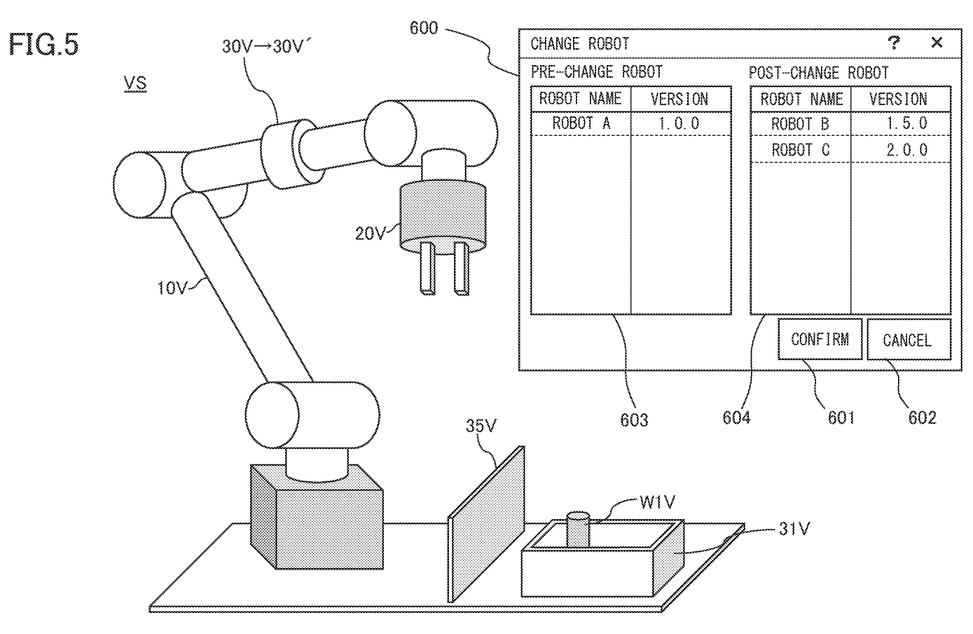

FIG. 5 is an explanatory diagram of the robot changing window 600 according to the embodiment. The robot changing window 600 illustrated in FIG. 5 is a graphical user interface (GUI) for changing the robot model 30V disposed in the virtual space VS to a different robot model 30V’ of a robot different from the robot 30. The robot changing window 600 is loaded from the SSD 454 and displayed on the display 402 as a result of the program 461 stored in the SSD 454 being executed by the CPU 451. Further, the robot changing window 600 includes a confirm button 601 for confirming the processing to replace the robot model 30V by the robot model 30V’, a cancel button 602 for cancelling the processing of replacing the robot model 30V by the robot model 30V’, a pre-change robot list display portion 603, a post-change robot list display portion 604. The pre-change robot list display portion 603 shows a list of robot models disposed in the virtual space VS before the change, that is, a list of robot models associated with information of a plurality of teaching points generated in advance. Although FIG. 5 illustrates an example of a case where only one robot model is disposed, there is a case where a plurality of robot models are disposed. In this case, the plurality of robot models are each associated with a plurality of teaching points corresponding thereto. In addition, the post-change robot list display portion 604 shows a list of candidates for the robot model after the change.

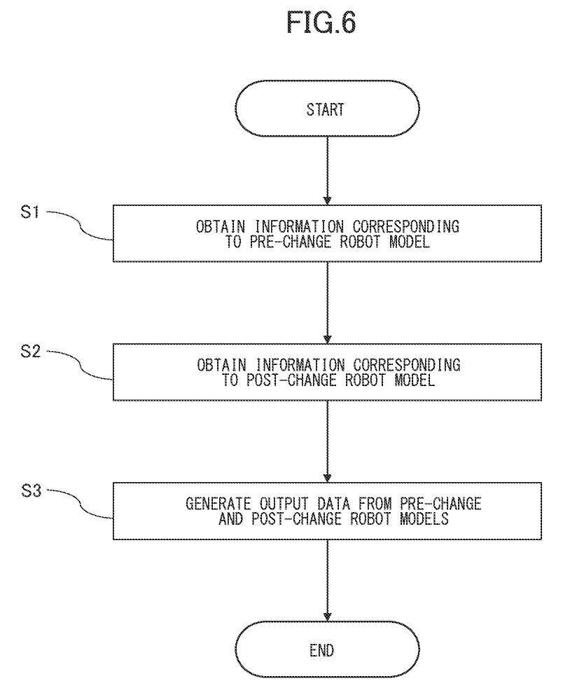

FIG. 6 is a flowchart related to a robot changing process according to the embodiment. As illustrated in FIG. 6, the CPU 451 executes the processing of step S1 for obtaining information corresponding to the pre-change robot model, the processing of step S2 for obtaining information corresponding to the post-change robot model, and the processing of step S3 for generating output data from the pre-change and post-change robot models. First, the processing of step S1 will be described.

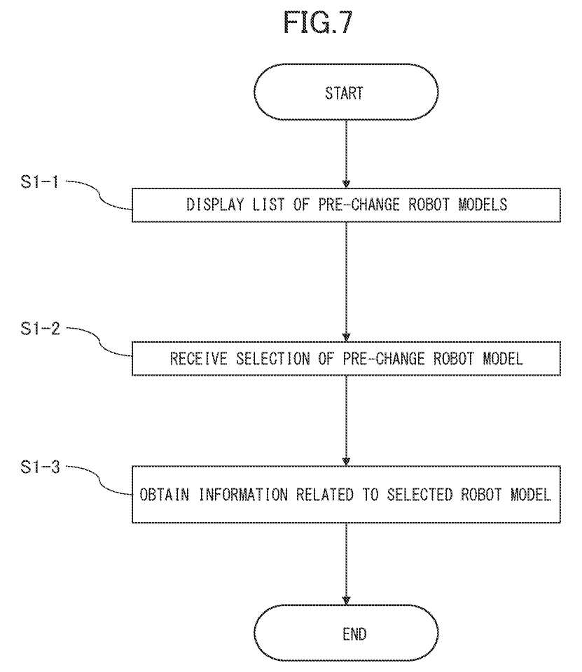

FIG. 7 is a flowchart of processing of step S1 of the robot changing process according to the embodiment. In step S1-1 illustrated in FIG. 7, the CPU 451 displays, in the pre-change robot list display portion 603, a list of robot models before the change that is registered in advance in the SSD 454 or the like of the simulator body 401. In the present embodiment, the CPU 451 displays, in the pre-change robot list display portion 603, a list of robot models loaded to the virtual space VS. In step S1-2, the CPU 451 receives selection of a robot model to be changed from the robot models displayed in the pre-change robot list display portion 603. In step S1-3, the CPU 451 obtains necessary information related to the selected pre-change robot model.

Specific description of steps S1-1, S1-2, and S1-3 will be given below. First, in step S1-1, when the robot changing window 600 is opened, the CPU 451 displays, in the pre-change robot list display portion 603, a list of robot models before the change that is registered in the simulator body 401 in advance. When displaying the list of the robot models, the CPU 451 checks whether or not the robot model in the virtual space VS satisfies configuration conditions as a robot. The configuration conditions are, for example, whether or not the plurality of links 11 to 16 of the robot model are properly coupled together by the plurality of joints J1 to J6 that are rotationally driven. The CPU 451 displays only robot models satisfying the configuration conditions as robots in the pre-change robot list display portion 603 as candidates.

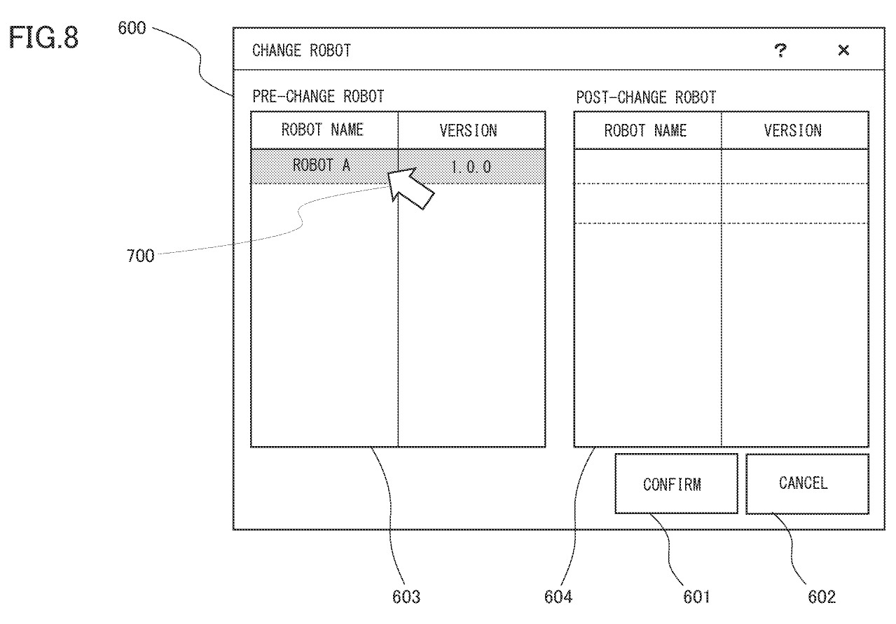

FIG. 8 is an explanatory diagram of processing of step S1-2 according to the embodiment. The CPU 451 receives selection of a pre-change robot model displayed in the pre-change robot list display portion 603. To be noted, in the example of FIG. 8, only one robot model can be selected.

In step S1-2, the CPU 451 receives selection from the pre-change robot models displayed in the pre-change robot list display portion 603 in step S1-1. Here, the CPU 451 displays, on the display 402, a cursor 700 that can be operated by the user by using the mouse 404. Further, the CPU 451 receives selection of a pre-change robot model by the user in response to the cursor 700 being operated by the mouse 404 with respect to the pre-change robot list display portion 603 and the mouse 404 being clicked on the pre-change robot model displayed in the pre-change robot list display portion 603.

In step S1-3, the CPU 451 obtains information that needs to be passed onto the post-change robot model in all the information about the pre-change robot model corresponding to the pre-change robot model selected in step S1-2. The information to be passed onto the post-change robot model will be also referred to as configuration information. The information (configuration information) to be passed onto the post-change robot model includes, for example, teaching points for the pre-change robot model, information of the TCP, interference setting information, information of parts accompanied by the pre-change robot model, information of relative coordinates of a mother part as viewed from each joint shaft, and information of base coordinates of the robot model.

Here, similarly to the robot 30, a control point that moves in an interlocked manner with a predetermined portion of the robot model 30V, for example, a hand model that is a distal end portion of the robot model 30V is also defined for the robot model 30V. The control point is a TCP, and is set in the vicinity of the predetermined portion of the robot model 30V, for example, in the vicinity of the hand model.

The information of the teaching points includes relative coordinate information of the position and posture of the distal end of the robot model with respect to the base of the robot model in the task space, information of a characteristic posture that can exist as a solution to inverse kinematics calculation on the teaching point, and information of the number of rotations of each shaft. The information of a characteristic posture that can exist as a solution to inverse kinematics calculation on the teaching point is, for example, in the case of a six-axis vertically articulated robot, information of the postures of the base, elbow, and wrist of the robot. The information of the characteristic posture is, for example, information of the positive and negative rotational direction of each of the plurality of joints with respect to the standard position thereof. To be noted, in the case where the joint is a prismatic joint, the information of the characteristic posture includes information of the positive and negative directions of linear motion with respect to the standard position. To be noted, in the case where a plurality of solutions can be obtained in the inverse kinematics calculation on the teaching point, the information of the teaching points also includes information of a characteristic posture that can exist as an alternative solution among the plurality of solutions.

The interference setting information is information of grouping settings of parts constituting the pre-change robot model.

In addition, in the case where the pre-change robot model has an abnormal posture, the information (configuration information) to be passed onto the post-change robot model includes information of a posture in which the abnormal posture occurs in the mechanism of the pre-change robot model, that is, information of the abnormal posture. The abnormal posture is, for example, in the case where the six-axis vertically articulated robot in which the fourth axis, the fifth axis, and the sixth axis are orthogonal to each other, a posture in which the fifth axis is at an angle that is 0° or a multiple of 180°. The configuration information as described above is information set for operating the robot.

In addition, the information (configuration information) to be passed onto the post-change robot model includes model parameters. The model parameters include, for example, information of the relative coordinates and posture of the position of the base of the robot model 30V in the task space, and information of the relative coordinates and posture of the position of the distal end of the robot model 30V in the task space.

To be noted, the information to be passed onto the post-change robot model is not limited to the example described above, and other information may be obtained in addition to the example described above if necessary.

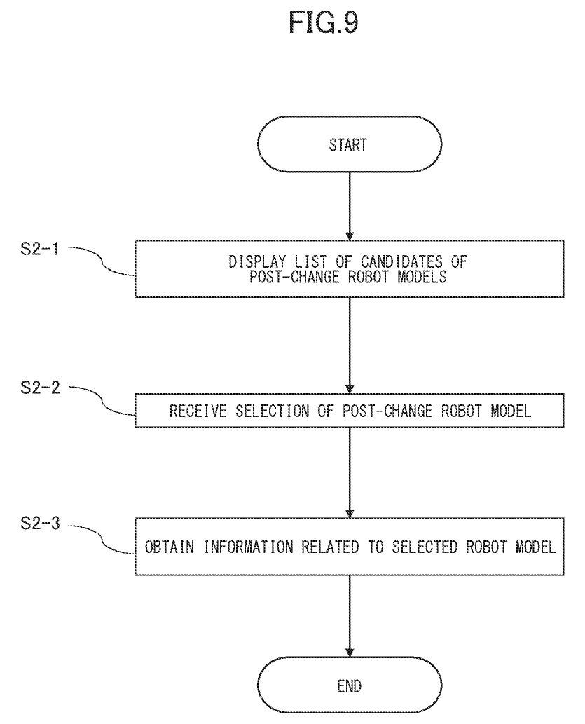

FIG. 9 is a flowchart of the processing of step S2 of the robot changing process according to the embodiment. In step S2-1 illustrated in FIG. 9, the CPU 451 displays, in the post-change robot list display portion 604, a list of candidates of the post-change robot models that is registered in advance in the SSD 454 or the like of the simulator body 401. In step S2-2, the CPU 451 receives selection of a post-change robot model from the candidates displayed in the post-change robot list display portion 604. In step S2-3, the CPU 451 obtains necessary information related to the selected post-change robot model.

Specific description of steps S2-1, S2-2, and S2-3 will be given below. First, in step S2-1, when the robot changing window 600 is opened, the CPU 451 displays, in the post-change robot list display portion 604, a list of candidates of robot models after the change that is registered in the simulator body 401 in advance. When displaying the list of candidates of the robot models, the CPU 451 checks whether or not the robot model in the virtual space VS satisfies configuration conditions as a robot. The configuration conditions are, for example, whether or not the plurality of links 11 to 16 of the robot model are properly coupled together by the plurality of joints J1 to J6 that are rotationally driven. The CPU 451 displays only robot models satisfying the configuration conditions as robots in the post-change robot list display portion 604 as candidates.

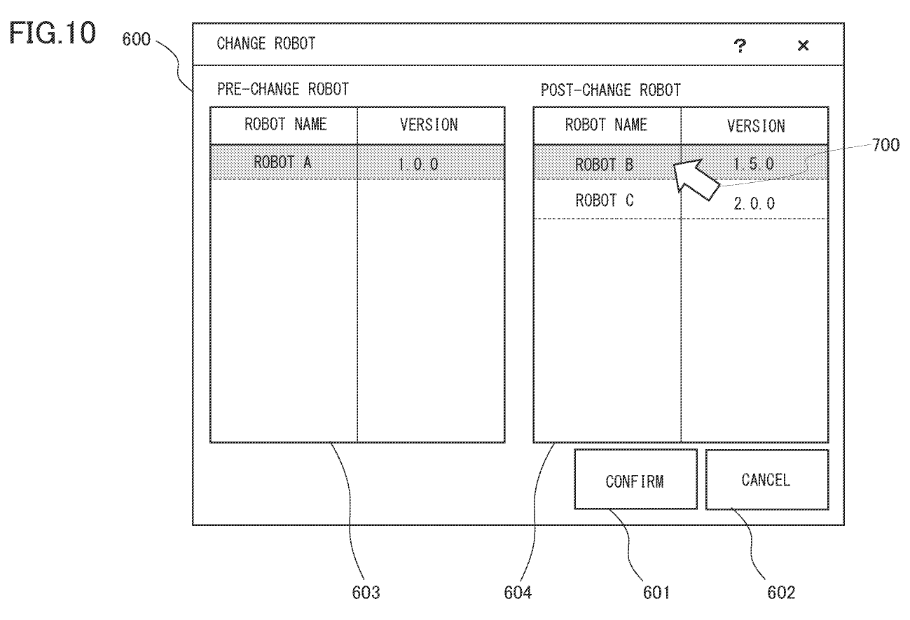

FIG. 10 is an explanatory diagram of processing of step S2-2 according to the embodiment. To be noted, in the example of FIG. 10, a plurality of candidates of robot models are displayed in the post-change robot list display portion 604 as at least one candidate of robot model. The CPU 451 receives selection of a post-change robot model displayed in the post-change robot list display portion 604. In step S2-2, the CPU 451 receives selection from the candidates of post-change robot models displayed in the post-change robot list display portion 604 in step S2-1. The CPU 451 receives selection of a post-change robot model by the user in response to the cursor 700 being operated by the mouse 404 with respect to the post-change robot list display portion 604 and the mouse 404 being clicked on a candidate of the post-change robot model displayed in the post-change robot list display portion 604.

In step S2-3, the CPU 451 obtains necessary information for the post-change robot model selected in step S2-2. Here, the information necessary for the post-change robot model is, for example, among all the information necessary for the post-change robot model, information other than the configuration information obtained from a first robot model, for example, three-dimensional shape information (including information of the length of each link) included in the post-change robot model, information of parts accompanied by the post-change robot model, and information of relative coordinates of a mother part as viewed from each joint shaft. To be noted, the information necessary for the post-change robot model is not limited to the example described above, and other information may be obtained in addition to the example described above if necessary.

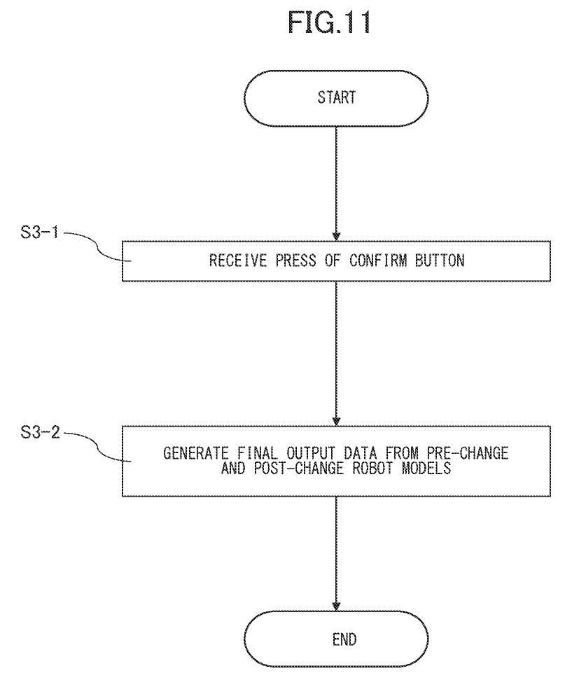

FIG. 11 is a flowchart of processing of step S3 of the robot changing process according to the embodiment. In step S3-1, the CPU 451 confirms the content of processing of steps S1 and S2 in response to receiving press of the confirm button 601. Then, in step S3-2, the CPU 451 generates final output data including the information (configuration information) to be passed onto the post-change robot model from the pre-change robot model, and the information necessary for the post-change robot model.

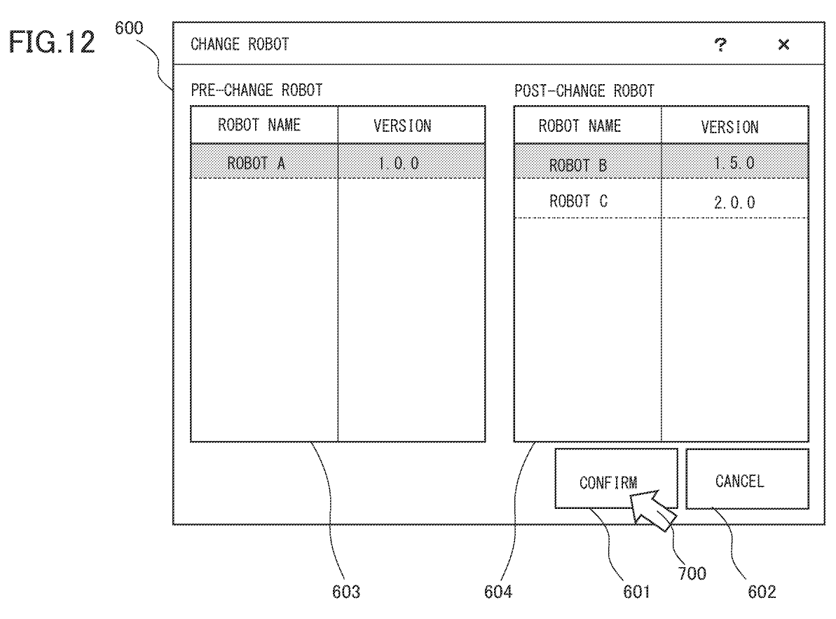

FIG. 12 is an explanatory diagram of the processing of step S3-1 according to the embodiment. In step S3-1, the CPU 451 confirms the selection processing of the pre-change robot model in step S1 and the selection processing of the post-change robot model in step S2 in response to the cursor 700 being operated by the mouse 404 and the mouse 404 being clicked on the confirm button 601.

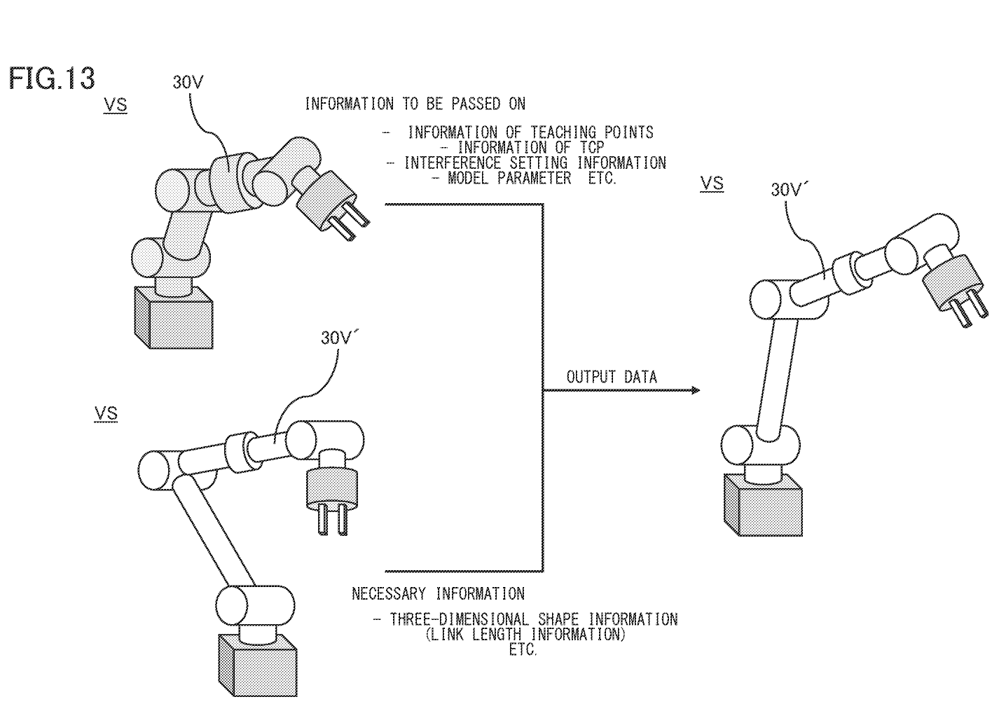

FIG. 13 is an explanatory diagram of the processing of step S3-2 according to the embodiment. In step S3-2, the CPU 451 generates integrated information for the post-change robot model 30V’ as output data on the basis of the configuration information (information to be passed on) for the pre-change robot model 30V and the information necessary for the post-change robot model 30V’. Here, the robot model 30V is an example of a first robot model, and the robot model 30V’ is an example of a second robot model.

Teaching points set for the post-change robot model 30V’ are obtained by converting the teaching points in the task space set for the pre-change robot model 30V into teaching points in the joint space. The teaching points in the task space are defined as relative coordinates of the control point (TCP) with respect to the base of the robot in the task space. Therefore, the teaching points in the joint space are obtained by inverse kinematics calculation of the post-change robot model 30V’ from the teaching points in the task space by using the information of the posture of the post-change robot model 30V’ and the information of the link length of the post-change robot model 30V’ as constants.

Here, the information associated with the post-change robot model 30V’ other than the information of the teaching points is selectively set from information obtained for the pre-change robot model 30V and information obtained for the post-change robot model 30V’. Examples of the information selected from the pre-change robot model 30V include configuration information such as information of the TCP, interference setting information, coordinate information of the base position of the robot model 30V, and information of tools (for example, hand model) attached to the robot model 30V in addition to the information of the teaching points. In addition, examples of the information selected from the post-change robot model 30V’ include the configuration information of the robot model 30V’ and information of 3D-CAD.

As described above, in the present embodiment, the CPU 451 executes processing of virtually operating the robot model 30V’ by using the configuration information of the robot model 30V. By using the configuration information of the robot model 30V for the robot model 30V’, the workload for the re-teaching in the case of changing the model of the robot can be reduced.

Here, in the case where the CPU 451 virtually operates the robot model 30V’ on the basis of the configuration information of the robot model 30V, a specific state can occur in the robot model 30V’. The specific state is a state in which the virtual operation of the robot model 30V’ has failed. In the present embodiment, examples of the specific state include a state (interference state) in which the robot model 30V’ interferes with an obstacle model, a state (abnormal state) in which the robot model 30V’ is in an abnormal posture, and a state (no-solution state) in which the robot model 30V’ is out of a movable range. Here, the robot model 30V’ interfering with the obstacle model includes the robot model 30V’ being in contact with the obstacle model (for example, the tray model 31V or the wall model 35V) and the robot model 30V’ intersecting with the obstacle model.

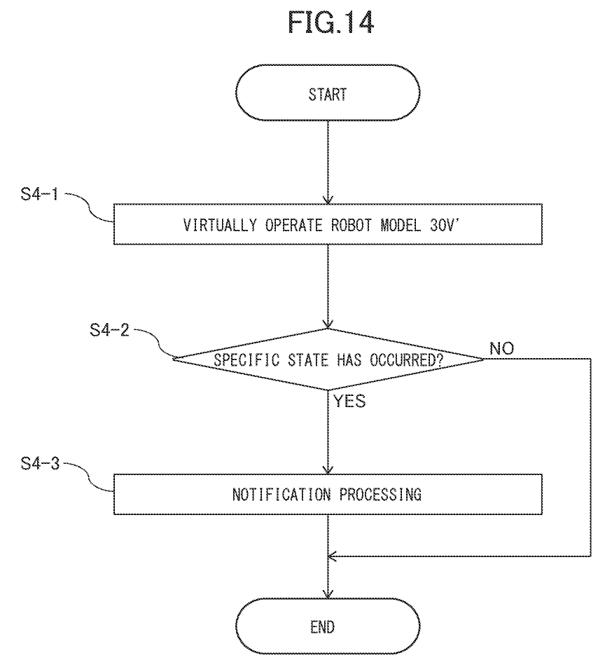

FIG. 14 is a flowchart of an information processing method according to the embodiment. The flowchart illustrated in FIG. 14 is executed after the press on the confirm button 601 illustrated in FIG. 12 is received in step S3-1 illustrated in FIG. 11 and the output data is generated in step S3-2. In step S4-1, the CPU 451 executes simulation processing of causing the robot model 30V’ to perform a virtual operation by using the configuration information used for causing the robot model 30V to perform a virtual operation. The processing of step S4-1 is an example of first processing.

The CPU 451 determines whether or not a specific state has occurred in the virtual operation of the robot model 30V’, that is, whether or not the virtual operation of the robot model 30V’ has failed.

In the case where the result of step S4-2 is YES, that is, in the case where the robot model 30V’ has taken the specific state in the virtual operation of the robot model 30V’, the CPU 451 proceeds to the processing of step S4-3. That is, in the case where the virtual operation of the robot model 30V’ has failed, the CPU 451 proceeds to the processing of step S4-3. In step S4-3, the CPU 451 executes notification processing of notifying a user that the robot model 30V’ has taken the specific state. The notification processing is an example of second processing. In the present embodiment, in the notification processing, the CPU 451 displays a screen indicating that the robot model 30V’ has taken the specific state on the display 402. To be noted, in the case where the result of step S4-2 is NO, that is, in the case where the robot model 30V’ has not taken the specific state in the virtual operation of the robot model 30V’, the CPU 451 finishes the processing.

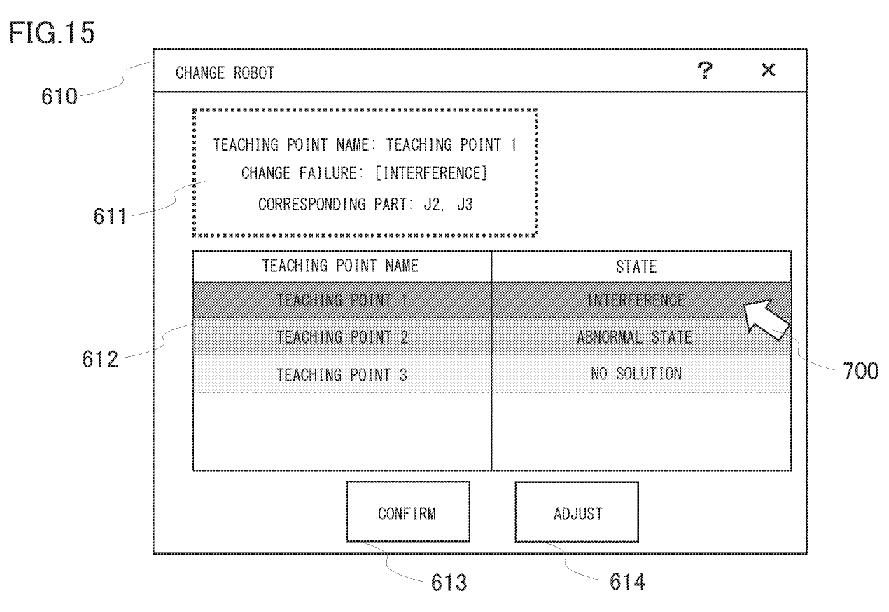

FIG. 15 is an explanatory diagram of a display screen 610 according to the embodiment. In the present embodiment, in the notification processing of step S4-2, the CPU 451 displays the display screen 610 illustrated in FIG. 15 on the display 402. The display screen 610 includes a cause display portion 611, a list display portion 612, a confirm button 613 for confirming the robot changing process, and an adjust button 614 for adjusting the robot changing process.

The display screen 610 functions as a GUI for notifying the user that the post-change robot model 30V’ takes the specific state.

The CPU 451 displays the teaching point at which the specific state is taken and the detail of the specific state in the list display portion 612 of the display screen 610. Here, the CPU 451 displays, on the display 402, the cursor 700 that the user can operate by using the mouse 404. Then, the CPU 451 receives selection of a teaching point in response to the cursor 700 being operated by the mouse 404 by the user with respect to the list display portion 612 and the mouse 404 being clicked on a display image of a teaching point at which the specific state is taken that is displayed in the list display portion 612. Then, the CPU 451 displays, for the selected teaching point, information of a cause of the specific state and a portion of the robot model corresponding thereto in the cause display portion 611. The detail of the specific state corresponding to the teaching point selected by the mouse 404 is displayed in the cause display portion 611, and the user can check the detail of the specific state by referring to the cause display portion 611.

Here, in the case where the confirm button 613 in the display screen 610 is pressed by the user, the CPU 451 performs the robot changing process while allowing the teaching point where the specific state is taken. That is, the CPU 451 invalidates the teaching point where the specific state is taken. In the case where the adjust button 614 in the display screen 610 is pressed by the user, the CPU 451 adjusts the robot changing process. The processing by the CPU 451 in the case where the adjust button 614 is pressed by the user will be described below.

In the notification processing, the CPU 451 notifies the user of candidates of the posture of the robot model 30V’ for avoiding the specific state. In the present embodiment, the CPU 451 displays the candidates of the posture of the robot model 30V’ for avoiding the specific state on the display 402.

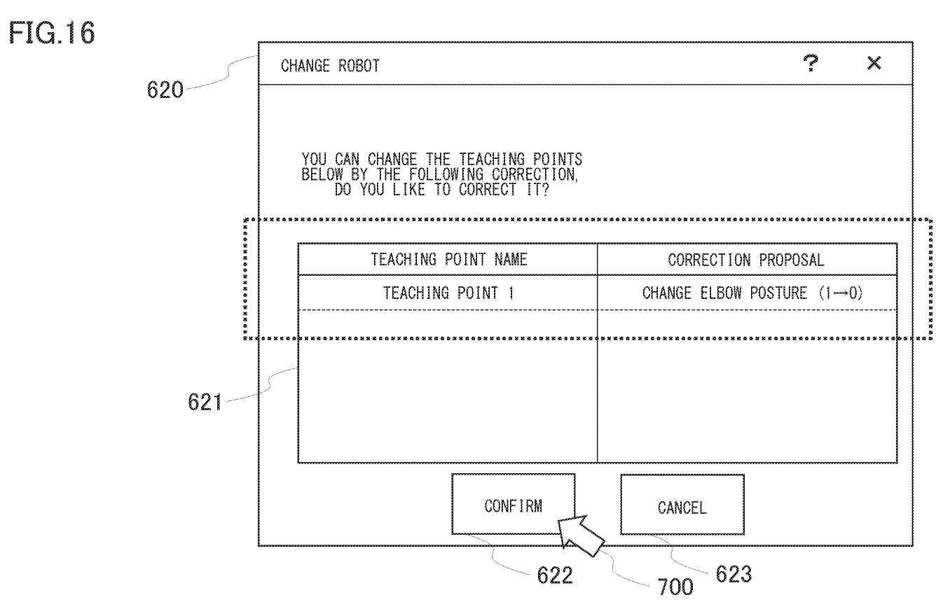

FIG. 16 is an explanatory diagram of a presentation screen 620 according to the embodiment. The presentation screen 620 includes a presentation list portion 621, a confirm button 622 for confirming the correction of the robot changing process, and a cancel button 623 for cancelling the correction of the robot changing process.

The presentation screen 620 functions as a GUI for presenting a correction proposal to the user and executing the correction in the case where the post-change robot model 30V’ is capable of avoiding the specific state in the processing in which adjustment of the robot changing process is executed when the adjust button 614 on the display screen 610 is pressed.

In the case where there is a method for correction to avoid the specific state for the teaching point where the specific state occurs, the CPU 451 displays a teaching point name and a correction proposal to avoid the specific state in the presentation list portion 621.

An example of obtaining the correction method by which the specific state can be avoided will be described. For example, in the case where the interference state can be avoided by changing the information of the characteristic posture (for example, in the case of a six-axis vertically articulated robot, the posture of the base, elbow, or wrist) that can exist as an alternative solution of the inverse kinematics calculation for the teaching point of interest, the CPU 451 presents the posture to the user as a correction proposal. That is, the CPU 451 obtains a candidate of the posture of the robot model 30V’ to avoid the specific state, by inverse kinematics calculation of the robot model 30V’ for the corresponding teaching point.

Specifically, in step S4-1, the CPU 451 obtains the posture of the robot model 30V’ in which the TCP moves to the teaching point, by inverse kinematics calculation. In the case where a plurality of solutions are obtained by the inverse kinematics calculation, the CPU 451 sets, as the posture of the robot model 30V’, a solution in which the characteristic posture of the robot model 30V’ is the same as the characteristic posture of the robot model 30V among the plurality of solutions.

As a result, in the case where the robot model 30V’ is in the specific state in step S4-2 and the robot model 30V’ is not in the specific state in an alternative solution in the plurality of solutions obtained by the inverse kinematics calculation, the CPU 451 presents the alternative solution to the user as a candidate of the posture of the robot model 30V’ in step S4-3. In the example of FIG. 16, a correction proposal of the teaching point where the specific state can be avoided by the correction is displayed in a region enclosed by a broken line frame.

The CPU 451 executes correction processing to avoid the specific state in the case where the confirm button 622 is pressed by the user. In addition, in the case where the cancel button 623 is pressed, the CPU 451 stops the corresponding processing, and transitions to the display screen 610. In the case where the confirm button 622 is pressed by the user, the CPU 451 executes correction to avoid the specific state, returns to step S3-2 of FIG. 11 after the correction, and continues the robot changing process.

As described above, the CPU 451 receives the selection of the candidate of the posture of the robot model 30V’ from the user, and sets the candidate of the posture of the robot model 30V’ whose selection has been received as the posture of the robot model 30V’.

According to the present embodiment, in the case where the specific state occurs in the post-change robot model 30V’ when the robot model 30V’ is virtually operated on the basis of the configuration information of the pre-change robot model 30V, the information indicating this is notified to the user, and thus the teaching of the robot is facilitated. As described above, according to the present embodiment, a technique advantageous for teaching of the robot is provided.

In addition, as a result of execution of correction processing to avoid the specific state, the workload for re-teaching in the case where the model of the robot is changed is reduced, and the operability is also improved.

As described above, according to the present disclosure, a technique advantageous in the case of setting the operation of the robot is provided.

To be noted, in the case where there is no way to preform direct correction regarding the teaching point related to the change in the embodiment described above, for example, in the case of a teaching point set to a position that the post-change robot model cannot physically reach, the teaching point is invalidated as “no solution”. However, the configuration is not limited to this. For example, the CPU 451 may set, as a new teaching point, a position and posture closest to the original teaching point within a range that the post-change robot model can reach.

In addition, although a case where a robot is virtually operated has been described as an example in the embodiment described above, the configuration is not limited to this. For example, a case where an actual robot is operated in a factory or the like will be considered. In this case, configuration information that is information set for operation a specific robot may be used in the case of using a different robot as a substitute of the specific robot. That is, the control apparatus operates a different robot on the basis of the configuration information set for the specific robot. For example, in the case of operating the different robot, the control apparatus obtains the posture information of the robot over time until the robot reaches each teaching point. Further, the control apparatus may stop the different robot in the case where, for example, the posture information obtained over time is close to the abnormal posture or the like as the specific state, and may notify the user about this situation. In this case, it is assumed that the surrounding environment is such that it can be confirmed that no interference occurs even if the different robot is operated. The determination regarding whether or not the obtained posture information is close to the abnormal posture or the like may be made by providing a threshold value for the difference between the obtained posture information and the abnormal posture.

In addition, a proximity sensor capable of detecting approach of an object thereto may be attached to each link of an actual robot, and the user may be notified in the case where interference between the actual robot and a surrounding object is expected as a specific state. That is, in the case of operating a different robot on the basis of the configuration information set for a specific robot, the control apparatus obtains information from the proximity sensors of the different robot over time. The control apparatus may stop the different robot in the case where, for example, the information from the proximity sensors obtained over time is close to a surrounding object, and may notify the user about this situation. The determination regarding whether or not the different robot is close to a surrounding object may be made by providing a threshold value for the information obtained from the proximity sensors.

In addition, the processing procedure executed by the simulator 400 of the embodiment described above is specifically executed by the CPU 451. Therefore, a configuration in which the CPU 451 reads a recording medium storing a software program capable of executing the function described above may be employed. In this case, the program itself read from the recording medium realizes the function of the embodiment described above.

In addition, although a case where the computer-readable recording medium is a ROM, a RAM, or an SSD, and the ROM, the RAM, or the SSD stores a program has been described in the embodiment described above, the configuration is not limited to this. The program may be stored in any recording medium as long as the recording medium is a non-transitory computer-readable recording medium. For example, a hard disk drive (HDD), an external storage device, a recording disk, or the like may be used as the recording medium for supplying the program.

Although a case where the robot arm is a vertically articulated robot arm has been described in the embodiment described above, the configuration is not limited to this. For example, the robot arm may be a horizontally articulated robot arm, a parallel link robot arm, or an orthogonal robot. In addition, the present disclosure is applicable to a machine capable of automatically performing contraction/extension, bending, vertical movement, horizontal movement, turning, or a composite operation of these on the basis of information in a storage device provided in the control apparatus.

In addition, although a case where the robot model 30V is changed to a different robot model 30V’ corresponding to a robot different from the robot 30 has been described in the embodiment described above, the target of change is not limited to this. A part model of part of the robot model, for example, an end effector model such as a hand model may be changed, and this case is also included in the example of change in the robot model.

In addition, the present disclosure is not limited to the embodiment described above, and the embodiment can be modified in many ways within the technical concept of the present disclosure. In addition, the effects described in the present embodiment are merely enumeration of the most preferable effects that can be obtained from the embodiment of the present disclosure, and the effects of the embodiment of the present disclosure are not limited to those described in the present embodiment.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-118692, filed July 24, 2024, which is hereby incorporated by reference herein in its entirety.

What is claimed is:

1. An information processing method executed by a processor, the method comprising:
execute first processing that causes a second robot model to perform a virtual operation by using configuration information used to cause a first robot model to perform a virtual operation; and
in a case where the second robot model has taken a specific state as a result of executing the first processing, execute second processing that notifies a user of the configuration information that has caused the second robot model to take the specific state.

2. The information processing method according to claim 1, wherein the second processing includes displaying, on a display apparatus, the configuration information that has caused the second robot model to take the specific state.

3. The information processing method according to claim 2,
wherein the configuration information includes information representing a teaching point of the first robot model, and
wherein the second processing includes displaying, on the display apparatus, the teaching point at which the specific state has occurred, in association with a detail of the specific state.

4. The information processing method according to claim 1, wherein the specific state includes at least one of a state in which the second robot model has failed a virtual operation, a state in which the second robot model interferes with an obstacle model, a state in which the second robot model takes an abnormal posture, or a state in which the second robot model is out of a movable range.

5. The information processing method according to claim 1, wherein the configuration information includes at least one of information of a teaching point of the first robot model, information of a control point that moves in an interlocked manner with a predetermined portion of the first robot model, or a model parameter of the first robot model.

6. The information processing method according to claim 5, wherein the predetermined portion is a distal end portion of the first robot model.

7. The information processing method according to claim 1, further comprising receiving selection of the second robot model by a user from at least one robot model candidate.

8. The information processing method according to claim 1, further comprising notifying a user of a candidate of a posture of the second robot model by which the specific state is avoided in the second processing.

9. The information processing method according to claim 8, further comprising displaying, on a display apparatus, the candidate of the posture of the second robot model by which the specific state is avoided.

10. The information processing method according to claim 8,
wherein the configuration information includes information representing a teaching point of the first robot model, and
further comprising obtaining the candidate of the posture of the second robot model by which the specific state is avoided, by inverse kinematics calculation of the second robot model for the teaching point.

11. The information processing method according to claim 8, further comprising receiving selection of the candidate of the posture of the second robot model by a user and set, as the posture of the second robot model, the candidate of the posture of the received selection for the second robot model.

12. A robot system including a robot controlled by using information obtained by the information processing method according to claim 1.

13. An information processing apparatus comprising:
a memory storing instructions; and
a processor, that upon execution of the stored instructions, is configured to perform information processing including
causing a second robot model to perform a virtual operation by using configuration information used for causing a first robot model to perform a virtual operation; and
in a case where the second robot model has taken a specific state as a result of causing the second robot model to perform a virtual operation, notify a user of the configuration information that has caused the second robot model to take the specific state.

14. A method for manufacturing a product comprising manufacturing the product by using a robot controlled by using information obtained by the information processing method according to claim 1.

15. A non-transitory computer-readable recording medium storing a program that when executed by a processor, causes a computer to execute the information processing method according to claim 1.
